(19) United States
(12) Patent Application Publication
(10) Pub. No.: US 2017/0042121 A1
(43) Pub. Date: Feb. 16, 2017

(54) ANIMAL MANAGEMENT SYSTEM

(71) Applicants: Michael Joseph Jersa, III, Wildwood, MO (US); Suhasini Balachandran, Bangalore (IN)

(72) Inventors: Michael Joseph Jersa, III, Wildwood, MO (US); Suhasini Balachandran, Bangalore (IN)

(21) Appl. No.: 15/007,327

(22) Filed: Jan. 27, 2016

Related U.S. Application Data
(60) Provisional application No. 62/203,006, filed on Aug. 10, 2015.

(51) Int. Cl. A01K 15/02; A01K 29/00; A01K 5/02

(52) U.S. Cl. CPC A01K 15/023; A01K 15/021; A01K 5/02; A01K 29/005; A01K 15/025

(57) ABSTRACT

A method and apparatus for coupling an animal managing device to an animal, coupling an electronic receiver to an electronic device, wherein the animal managing device adapted to be in electronic communication with the electronic receiver, receiving an electronic signal by the electronic receiver from the animal managing device are disclosed. Electronically coupling a sound emitting device to the electronic receiver, and activating the sound emitting device by means of the electronic receiver to emit at least one of an audible sound and a first ultrasonic frequency signal when the animal managing device reaches a first displacement from the electronic device are also disclosed. Other embodiments of the invention are also described.

### FIELD OF THE INVENTION

This invention relates to an animal management system, and more particularly to a method and apparatus for coupling an electronic device to an animal managing device.

### BACKGROUND OF THE INVENTION

Most animal owners employ an animal managing device that may be coupled to an animal. A traditional animal managing device includes a fastener that is adapted to be wound about the animal. An electric stimulus applying module may be coupled to the fastener. When the animal moves beyond an acceptable location (typically a fixed Wi-Fi system or a buried underground wire establishes an “invisible fence”), an electric stimulus is applied on the animal by means of the electric stimulus applying module. Consequently, apart from creating awareness in the animal, the animal may not realize that it is required to return within a perimeter of the acceptable location. Moreover, during circumstances when it may be required to gather physical data pertaining to the animal, the user may be required to deploy several mutually exclusive animal managing devices, wherein the several mutually exclusive animal managing devices may also be unavailable.

### BRIEF DESCRIPTION OF THE INVENTION

In one aspect of the invention, an animal management system is described. The animal management system comprises an animal managing device, wherein the animal managing device adapted to be coupled to an animal. The animal management system comprises an electronic device in electronic communication with the animal managing device, wherein the electronic device comprises an electronic receiver, and wherein the electronic receiver is adapted to receive a first electronic signal from the animal managing device. A sound emitting device is in electronic communication with the electronic receiver, the electronic receiver adapted to activate the sound emitting device to emit at least one of an audible sound and a first ultrasonic frequency signal when the animal managing device reaches a first displacement from the electronic device.

In another aspect of the invention, an electronic device for managing an animal is described. The electronic device comprises an electronic receiver coupled to the electronic device, the electronic receiver adapted to receive an electronic signal from an animal managing device. A sound emitting device is in electronic communication with the electronic receiver, the electronic receiver adapted to activate the sound emitting device to emit at least one of an audible sound and a first ultrasonic frequency signal when the animal managing device reaches a first displacement from the electronic device.

In yet another aspect of the invention, an animal managing device adapted to be coupled to an animal is described. The animal managing device comprises a collar, and an electronic transmitter adapted to be coupled to the collar. At least one electronic component is adapted to be in electronic communication with the electronic transmitter.

Other objects and features of the invention will be in part apparent and in part pointed out hereinafter.

### BRIEF DESCRIPTION OF THE DRAWINGS

FIG. 1 is a schematic representation of an electronic device in electronic communication with an animal managing device.

FIG. 2 is a schematic representation of the electronic device displaying electronic components that may be integrated in the electronic device, wherein the electronic device is adapted to be in electronic communication with the animal managing device, and an animal deterrent device in electronic communication with the animal managing device.

FIG. 3 is a schematic representation of at least one electronic component that may be coupled to the animal managing device.

FIG. 4 is a schematic representation of a Bluetooth® device that may be coupled to the animal managing device and adapted to operate an accessory.

### DETAILED DESCRIPTION OF THE INVENTION

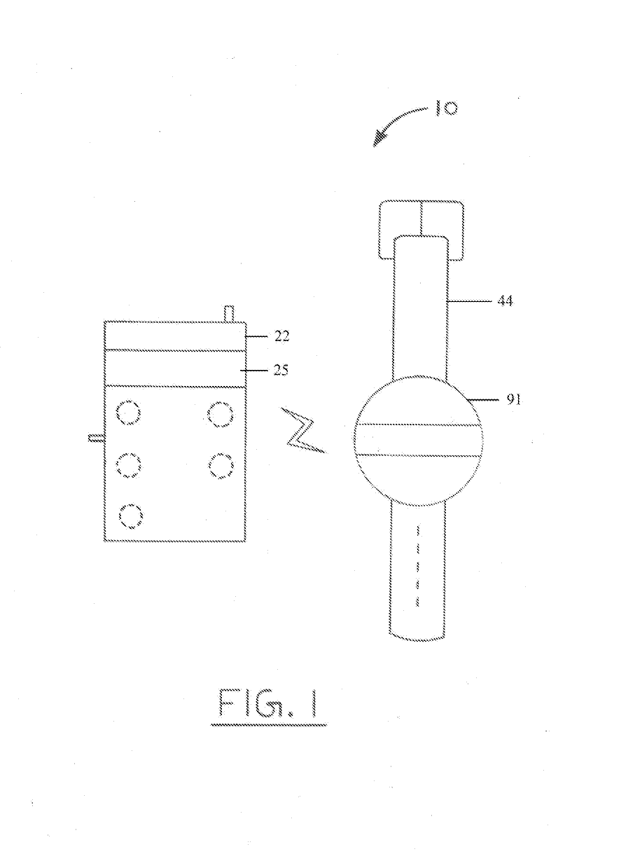

FIG. 1 is a schematic representation of an animal management system 10. More specifically, in the exemplary embodiment, an electronic device 22 is in electronic communication with an animal managing device 91. The electronic device 22 may be any device known in the art that may be capable of electronically communicating with the animal managing device 91. In an exemplary embodiment, the electronic device 22 includes but is not limited to a cell phone, a smart container, a wrist watch, a pager, a remote control device, a Bluetooth® device, a CDMA device, a radio device, a computer system, a Wi-Fi device, a GPS device, a tracking device, and the like. The animal managing device 91 may be any type of device that may be coupled to an animal, wherein the animal may be a dog, a cat, a cow, a sheep, a goat, a bird, a reptile, a fish, a dolphin, a whale, an elephant, an amphibian, or any other creature that constitutes a part of the animal kingdom.

The animal managing device 91 may be any type of wireless/wired electronic communication device known in the art that may be capable of transmitting/receiving electronic signals to/from the electronic device 22. Moreover, the animal managing device 91 may be any type of electronic device that is capable of being coupled to the animal. The animal managing device 91 may be a collar 44 with a disc that may be coupled to the collar 44. In an alternate embodiment, the animal managing device 91 may be a saddle, a rope, a cord, a band, a strap, a harass, a belt, a lace, a garment, or any other fastening means that is adapted to be fastened to the animal, and which includes the disc that is adapted to be coupled to the fastening means. In yet another alternate exemplary embodiment, the animal managing device 91 may be merely the fastening means with electronic components that may be coupled to the fastening means. The fastening means may be coupled to a fastening mechanism such as but not limited to a buckle, a hook and loop fastener, and the like, and wherein the fastening mechanism may be used to couple the fastening means to the animal. In an exemplary embodiment, the disc is adapted to be integrally coupled to the fastening means. In an alternate exemplary embodiment, the disc is adapted to be elastically/rigidly extendable from the fastening means such that the disc may be adapted to reach and couple to any portion of a body of the animal The terms collar, saddle, rope, band, strap, harass, cord, belt, lace, garment, and the like as described in the specification and in the claims may be construed to be used interchangeably. The electronic communication between the electronic device 22 and the animal managing device 91 is explained in further detail below.

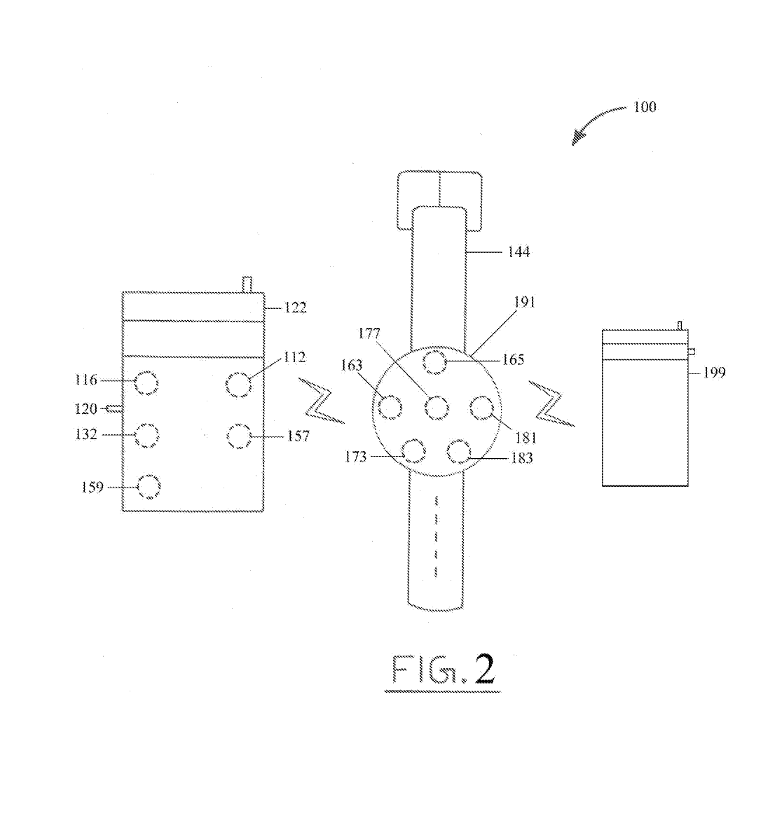

FIG. 2 is a schematic representation of the electronic device 122 displaying electronic components that are integrated in the electronic device 122. In the exemplary embodiment, the electronic device 122 includes an electronic transmitter 157. The electronic transmitter 157 is adapted to be integrated within the electronic device 122 and transmits an electronic signal to an electronic receiver 183 that is adapted to be coupled to the animal managing device 191. Specifically, the electronic signal transmitted by the electronic transmitter 157 of the electronic device 122 to the animal managing device 191 is transmitted to determine a geographical location of the animal managing device 191 with respect to the electronic device 122. In an alternate exemplary embodiment, the electronic signal transmitted by the electronic transmitter 157 of the electronic device 122 to the animal managing device 191 may be transmitted to facilitate initiating electronic communication between the electronic device 122 and the animal managing device 191. The initiation of electronic communication between the electronic device 122 and the electronic receiver 183 that is adapted to be coupled to the animal managing device 191 allows for data retrieval from the animal managing device 191. In an exemplary embodiment, the data retrieved from the animal managing device 191 may correspond to data retrieved from at least one electronic component 181 that is adapted to be coupled to the animal managing device 191 and in electronic communication with the electronic receiver 183. In an exemplary embodiment, the electronic signal transmitted by the electronic transmitter 157 of the electronic device 122 to the electronic receiver 183 may also be used to determine if the animal managing device 191 has exceeded an allowable displacement from the electronic device 122.

The electronic device 122 includes an electronic receiver 116. The electronic receiver 116 may be integrated within the electronic device 122 and receives an electronic signal from the animal managing device 191. Specifically, the electronic receiver 116 may be electronically coupled to an electronic transmitter 165 that may be coupled to the animal managing device 191 and receives the electronic signal that is transmitted from the electronic transmitter 165. In an exemplary embodiment, electronic receiver 116 may be a wireless radio receiver, a wireless Bluetooth® receiver, a wireless CDMA receiver, and the like depending on a signal range required by the user for receiving the electronic signal from the electronic transmitter 165. Alternatively, the electronic receiver 116 may be any type of wireless electronic receiver known in the art that receives an electromagnetic signal from the electronic transmitter 165. The electronic signal that is received by the electronic receiver 116 from the electronic transmitter 165 that may be coupled to the animal managing device 191 is used to determine the geographical location of the animal managing device 191 with respect to the electronic device 122. In an alternate exemplary embodiment, the electronic signal that may be retrieved by the electronic receiver 116 of the electronic device 122 comprises data retrieved from at least one electronic component 181 that is adapted to be coupled to the animal managing device 191. The at least one electronic component 181 that is adapted to be coupled to the animal managing device 191 may be in electronic communication with the electronic transmitter 165.

The electronic device 122 includes an ultrasonic device 132 that may be integrated therein. Alternatively, a sound emitting device capable of emitting audible sounds and ultrasonic frequency signals may be integrated in the electronic device 122. The terms ‘ultrasonic device’, ‘sound emitting device’, and the like as described in the specification and in the claims may be construed to be used interchangeably to mean the same type of device. The ultrasonic device 132 may be in electronic communication with at least one of the electronic transmitter 157 and the electronic receiver 116 of the electronic device 122. The ultrasonic device 132 may be coupled to at least one of the electronic transmitter 157 and the electronic receiver 116 of the electronic device 122 either directly or via one or more intermediate electronic components. One of the electronic transmitter 157 and the electronic receiver 116 of the electronic device 122 facilitates activating the ultrasonic device 132 to emit a signal of a first ultrasonic frequency when the animal managing device 191 reaches a first displacement from the electronic device 122. Specifically, the first displacement may be programmable in the electronic device 122 by a user. In an exemplary embodiment, a displacement range of the first displacement may be programmable by the user in the electronic device 122 to increase or decrease in accordance with the user's requirement.

When the animal managing device 191 exceeds the first displacement that has been programmed by the user, the electronic receiver 116 of the electronic device 122 receives an electronic signal from the electronic transmitter 165 of the animal managing device 191 that may be indicative that the animal managing device 191 has exceeded the first displacement. Specifically, when the animal managing device 191 exceeds the first displacement that has been programmed by the user, a signal strength established between the electronic receiver 116 of the electronic device 122 and the electronic transmitter 165 of the animal managing device 191 decreases. The decrease in signal strength is indicative that the animal managing device 191 has exceeded the first displacement. By activating the ultrasonic device 132 that emits the first ultrasonic frequency signal, the animal that is adapted to be coupled to the animal managing device 191 may be notified that it is required to retrace its path/revert to reach a displacement from the electronic device 122 that is lesser than or equal to the first displacement. Alternatively, when the electronic device 122 exceeds this first displacement that has been programmed by the user from the animal managing device 191, the electronic receiver 116 of the electronic device 122 receives an electronic signal from the electronic transmitter 165 of the animal managing device 191 that may be indicative that the electronic device 122 has exceeded the first displacement from the animal managing device 191.

In an alternate embodiment, the timed exchange of data packets between the electronic receiver 116 of the electronic device 122 and the electronic transmitter 165 of the animal managing device 191 may be another technique employed to determine that the animal managing device 191 has exceeded the first displacement. Specifically, an effective roundtrip time between data packets transmitted from the electronic device 122 to the animal managing device 191 and data packets transmitted from the electronic transmitter 165 of the animal managing device 191 to the electronic receiver 116 of the electronic device 122 may be used to determine that the animal managing device 191 has exceeded the first displacement. In further alternate embodiments such as but not limited to Wi-Fi positioning, fingerprinting, RSSI localization technique, GPS map displacement measurement technique, angle of arrival, time of flight localization technique, and the like may be used to determine that the animal managing device 191 has exceeded the first displacement. Alternatively, any method that is known in the art may be employed to determine that the animal managing device 191 has exceeded the first displacement.

When the animal that is adapted to be coupled to the animal managing device 191 reaches a displacement from the electronic device 122 that is lesser than or equal to the first displacement, the ultrasonic device 132 may be deactivated to stop emitting ultrasonic signals. In an exemplary embodiment, when the animal that is adapted to be coupled to the animal managing device 191 reaches a displacement from the electronic device 122 that is lesser than or equal to the first displacement, the electronic receiver 116 of the electronic device 122 receives an electronic signal from the electronic transmitter 165 of the animal managing device 191 that is indicative that the displacement of the animal managing device 191 is lesser than or equal to the first displacement. Alternatively, when the animal that is adapted to be coupled to the animal managing device 191 reaches a displacement from the electronic device 122 that is lesser than or equal to the first displacement, a signal strength established between the electronic receiver 116 of the electronic device 122 and the electronic transmitter 165 of the animal managing device 191 increases. The increase in signal strength is indicative that the displacement of the animal managing device 191 is lesser than or equal to the first displacement.

In an exemplary embodiment of the invention, the signal of the first ultrasonic frequency that may be emitted by the ultrasonic device 132 may be an intermittent ultrasonic frequency signal. In an alternate exemplary embodiment of the invention, the signal of the first ultrasonic frequency that may be emitted by the ultrasonic device 132 may be a continuous ultrasonic frequency signal.

The electronic receiver 116 facilitates activating the ultrasonic device 132 to emit a signal of a second ultrasonic frequency when the animal managing device 191 reaches a second displacement from the electronic device 122. Specifically, the second displacement may be programmed in the electronic device 122 by the user. When the animal managing device 191 exceeds this second displacement that has been programmed by the user, the electronic receiver 116 that may be coupled to the electronic device 122 receives an electronic signal from the electronic transmitter 165 of the animal managing device 191 that may be indicative that the animal managing device 191 has exceeded the second displacement. Alternatively, when the animal managing device 191 exceeds this second displacement that has been programmed by the user, a signal strength established between the electronic receiver 116 that is coupled to the electronic device 122 and the electronic transmitter 165 of the animal managing device 191 decreases more than when the animal managing device 191 exceeded the first displacement. The further reduction in signal strength may be indicative that the animal managing device 191 has exceeded the second displacement. Alternatively, any of the other techniques described above may be employed to determine if the animal managing device 191 has exceeded the second displacement. By activating the ultrasonic device 132 that emits the signal of the second ultrasonic frequency, the animal that is adapted to be coupled to the animal managing device 191 may be notified that it is required to retrace its path/revert to reach a displacement from the electronic device 122 that is lesser than or equal to the second displacement. Alternatively, any means of electronic signaling between the electronic device 122 and the animal managing device 191 may be used to notify the animal that it is required to retrace its path/revert to reach a displacement from the electronic device 122 that is lesser than or equal to the second displacement.

When the animal that is adapted to be coupled to the animal managing device 191 reaches a displacement from the electronic device 122 that is lesser than or equal to the second displacement, the ultrasonic device 132 is adapted to be activated by the electronic receiver 116 to emit the signal of the first ultrasonic frequency. This first ultrasonic frequency signal persists until the animal has retraced its path/reverted to reach a displacement from the electronic device 122 that is lesser than or equal to the first displacement.

In an exemplary embodiment, when the animal that is adapted to be coupled to the animal managing device 191 reaches a displacement from the electronic device 122 that is lesser than or equal to the second displacement, the electronic receiver 116 of the electronic device 122 receives an electronic signal from the electronic transmitter 165 of the animal managing device 191 that is indicative that the displacement of the animal managing device 191 is lesser than or equal to the second displacement. Alternatively, when the animal that is adapted to be coupled to the animal managing device 191 reaches a displacement from the electronic device 122 that is lesser than or equal to the second displacement, the signal strength established between the electronic receiver 116 of the electronic device 122 and the electronic transmitter 165 of the animal managing device 191 increases. The increase in signal strength is indicative that the displacement of the animal managing device 191 is lesser than or equal to the second displacement. Alternatively, any of the other techniques described above may be employed to determine if the animal managing device 191 has reached a displacement from the electronic device 122 that is lesser than or equal to the second displacement. The second displacement may be greater than the first displacement. When a locus of the second displacement and the first displacement is a circle, then a circumference of the second displacement may be larger than a circumference of the first displacement.

In an exemplary embodiment of the invention, the signal of the second ultrasonic frequency that may be emitted by the ultrasonic device 132 may be an intermittent ultrasonic frequency signal. In an alternate embodiment of the invention, the signal of the second ultrasonic frequency that may be emitted by the ultrasonic device 132 may be a continuous ultrasonic frequency signal.

A control unit 112 is adapted to be coupled to the electronic device 122. Specifically, the control unit 112 is adapted to be coupled to the electronic transmitter 157 and the electronic receiver 116 of the electronic device 122. Moreover, the control unit 112 is adapted to be coupled to the ultrasonic device 132. When the animal that is adapted to be coupled to the animal managing device 191 reaches a displacement from the electronic device 122 that is greater than or equal to the first displacement, the control unit 112 receives an electronic signal from one of the electronic transmitter 157 and the electronic receiver 116 of the electronic device 122. In an exemplary embodiment, the control unit 112 receives the electronic signal from one of the electronic transmitter 157 and the electronic receiver 116 either directly or via one or more intermediate electronic components. In response to the electronic signal that may be received from one of the electronic transmitter 157 and the electronic receiver 116, the control unit 112 activates the ultrasonic device 132 to emit the first ultrasonic frequency signal.

In an exemplary embodiment, the electronic device 122 includes a battery compartment (not shown). More specifically, the battery compartment is adapted to be provided within a recess defined within the electronic device 122. In an alternate exemplary embodiment, the battery compartment is adapted to be coupled to the electronic device 122. The battery compartment comprises at least one pair of positive and negative polarity electrical leads (not shown). The positive and negative polarity electrical leads receive a rechargeable battery therein. The control unit 112 may be in electronic communication with the positive and negative polarity electrical leads via a control flow path to constitute a closed loop electrical circuit. In an exemplary embodiment, power supplied by the rechargeable battery to the positive and negative polarity electrical leads powers the control unit 112 to facilitate activating the ultrasonic device 132. Therefore, all electronic components such as the electronic receiver 116, electronic transmitter 157, ultrasonic device 132, etc. that have been integrated/coupled to the electronic device 122 and in electronic communication with the control unit 112 may be electrically powered by the power supplied to the positive and negative polarity electrical leads by the rechargeable battery.

In an exemplary embodiment, the electronic device 122 includes a plurality of battery charging ports that are adapted to be coupled to the electronic device 122. More specifically, the battery charging ports are adapted to be in electronic communication with each pair of the positive and negative polarity electrical leads via control flow paths. More specifically, the battery charging ports of the electronic device 122 may be placed on a battery charging station for charging the rechargeable battery. In an alternate exemplary embodiment, any battery charger that is known in the art may be electrically coupled to the battery charging ports for charging the rechargeable battery. In yet another alternate exemplary embodiment, power may be supplied directly to the control unit 112 using an external power source via a control flow path.

An inductive battery charger (not shown) may be provided which is platform shaped and which may be provided with a charging coil. When the charging coil in the inductive battery charger is energized, the charging coil creates magnetic flux lines. The battery charging ports of the electronic device 122 may be in a non-direct electrical contact relationship with respect to the inductive battery charger. The battery charging ports includes a pick-up coil which will have an electrical current induced therein when the battery charging ports are positioned adjacent to the inductive battery charger, and the inductive battery charger is energized. The electronic device 122 includes circuit means for rectifying the induced current in the pick-up coil to charge the rechargeable battery received within the positive and negative polarity electrical leads. The circuit means includes a rectifier and a current limiting resistor so that the rechargeable battery is adapted to be self regulating in terms of current and overcharge.

In an exemplary embodiment, the electronic device 122 includes a digital display screen 25 that is adapted to be coupled to an outer sidewall of the electronic device 122. More specifically, a touch screen selector is adapted to be in electronic communication with the digital display screen 25 and may be operated by the user to display a location of the animal managing device 191 with reference to the electronic device 122. The digital display screen 25 is adapted to be coupled to the control unit 112. The location of the animal managing device 191 with reference to the electronic device 122 that may be displayed on the digital display screen 25 may be received in the electronic receiver 116 from the electronic transmitter 165 of the animal managing device 191. In an exemplary embodiment, the digital display screen 25 may be an LCD screen, TFT screen, TFT active matrix screen, black and white screen, CSTN screen, and a plasma screen. Alternatively, the digital display screen 25 may be any display screen known in the art that may be capable of displaying a location of the animal managing device 191 with reference to the electronic device 122. More typically, the electronic device 122 includes speakers, head phones or similar devices for producing an audio signal for the content displayed on the digital display screen 25 that may be received by the electronic receiver 116 from the electronic transmitter 165 of the animal managing device 191. The digital display screen 25 has a resolution from about 240×320 to 480×640 and preferably is a 16-18 bit color screen for displaying a location of the animal managing device 191 with reference to the electronic device 122. In an exemplary embodiment, the location of the animal managing device 191 with reference to the electronic device 122 may be captured by means of a motion video recording. Alternatively, a location of the animal managing device 191 may be captured on a geographical map. In an exemplary embodiment, the digital display screen 25 is adapted to be coupled to the electronic device 122. The digital display screen 25 is adapted to be coupled circumferentially to the electronic device 122 such that a portion of the electronic device 122 that includes various electronic transducers, switches, and the like do not constitute a portion of the digital display screen 25. In an alternate exemplary embodiment, all user selector options for running any application may be performed using the touch screen selector that may be in electronic communication with the digital display screen 25. When the animal managing device 191 exceeds at least one of the first displacement, and the second displacement that has been programmed by the user, the electronic receiver 116 of the electronic device 122 receives an electronic signal from the electronic transmitter 165 of the animal managing device 191 that may be indicative that the animal managing device 191 has exceeded at least one of the first displacement and the second displacement respectively. The electronic receiver 116 of the electronic device 122 facilitates displaying a notification message on the digital display screen 25 notifying the user that the animal managing device 191 has exceeded the first displacement. In an alternate exemplary embodiment, the electronic receiver 116 of the electronic device 122 facilitates displaying a notification message on the digital display screen 25 notifying the user that the animal managing device 191 has exceeded the second displacement.

In an exemplary embodiment of the invention, an electric stimulus applying module 177 is adapted to be coupled to the animal managing device 191. The electric stimulus applying module 177 may be in electronic communication with the control unit 112. Alternatively, the electric stimulus applying module 177 is adapted to be in electronic communication with the electronic transmitter 157 of the electronic device 122. The electric stimulus applying module 177 may be activated to apply an electric stimulus on the animal when the animal managing device 191 reaches a third displacement from the electronic device 122. In an alternate exemplary embodiment, a speaker adapted to be coupled to the animal managing device 191 may be activated to emit a piercing sound/bothersome sound when the animal managing device 191 reaches a third displacement from the electronic device 122. The third displacement may be greater than the second displacement. When the locus of the second displacement and the third displacement is a circle, then the circumference of the third displacement may be larger than the circumference of the second displacement. When the animal managing device 191 exceeds the third displacement from the electronic device 122, a magnitude of the electric stimulus applied by the electric stimulus applying module 177 on the animal increases. Alternatively, when the animal managing device 191 exceeds the third displacement from the electronic device 122, the intensity of the piercing sound/bothersome sound that is emitted by the speaker increases.

When the animal that is adapted to be coupled to the animal managing device 191 reaches a displacement from the electronic device 122 that is lesser than or equal to the third displacement, the electric stimulus applying module 177 may be deactivated. In an exemplary embodiment, when the animal that is adapted to be coupled to the animal managing device 191 reaches a displacement from the electronic device 122 that is lesser than or equal to the third displacement, the electronic receiver 116 of the electronic device 122 receives an electronic signal from the electronic transmitter 165 of the animal managing device 191 that may be indicative that the displacement of the animal managing device 191 is lesser than or equal to the third displacement. Alternatively, when the animal that is adapted to be coupled to the animal managing device 191 reaches a displacement from the electronic device 122 that is lesser than or equal to the third displacement, a signal strength established between the electronic receiver 116 of the electronic device 122 and the electronic transmitter 165 of the animal managing device 191 increases. The increase in signal strength is indicative that the displacement of the animal managing device 191 is lesser than or equal to the third displacement. Alternatively, any of the other techniques described above may be employed to determine if the animal managing device 191 has reached a displacement from the electronic device 122 that is lesser than or equal to the third displacement. The third displacement may be greater than the second displacement. When the animal managing device 191 exceeds the third displacement, the electronic receiver 116 of the electronic device 122 receives an electronic signal from the electronic transmitter 165 of the animal managing device 191 that may be indicative that the animal managing device 191 has exceeded the third displacement. The electronic receiver 116 of the electronic device 122 facilitates displaying a notification message on the digital display screen 25 notifying the user that the animal managing device 191 has exceeded the third displacement.

The electric stimulus applying module 177 may be electrically powered by the battery that is adapted to be inserted within/coupled to the animal managing device 191. Alternatively, any other power source that may be known in the art is adapted to be inserted within/coupled to the animal managing device 191 and supplies electric power to the electric stimulus applying module 177. In an exemplary embodiment, a magnitude of the electric stimulus applied by the electric stimulus applying module 177 on the animal may be programmable by the user in the electronic device 122. In an alternate exemplary embodiment, a magnitude of the electric stimulus applied by the electric stimulus applying module 177 on the animal may be pre-programmed in the electronic device 122.

In an exemplary embodiment of the invention, a magnitude of the first displacement, the second displacement, and the third displacement may be programmable in the electronic device 122 by the user. In an alternate exemplary embodiment, the magnitude of the first displacement, the second displacement, and the third displacement may be pre-programmed in the electronic device 122 during a manufacturing/testing phase of the electronic device 122.

In an exemplary embodiment, a magnitude of the electric stimulus applied by the electric stimulus applying module 177 on the animal increases when the animal managing device 191 exceeds the third displacement from the electronic device 122. Therefore, as the animal that may be coupled to the animal managing device 191 moves further away beyond the third displacement from the electronic device 122, a magnitude of the electric stimulus applied by the electric stimulus applying module 177 on the animal may continuously increase in a linear manner. Alternatively, as the animal that is adapted to be coupled to the animal managing device 191 moves further away beyond the third displacement from the electronic device 122, a magnitude of the electric stimulus applied by the electric stimulus applying module 177 on the animal may be programmed to remain steady, or disengage after a period of time.

In an exemplary embodiment, the animal managing device 191 includes a vibrating unit (not shown). The vibrating unit is adapted to be in electronic communication with the electronic device 122. The vibrating unit may be activated to apply a vibration stimulus on the animal when the animal managing device 191 reaches the third displacement from the electronic device 122. Alternatively, the vibrating device/electric stimulus applying module 177 may be activated to apply a vibration stimulus/electric stimulus on the animal when activated by the user. As a consequence of the vibrations/electric stimulus sensed by the animal, the animal may be cognizant that it is required to return within the perimeter of the first displacement from the electronic device 122. Alternatively, an audible alarm is adapted to be coupled to the animal managing device 191 and emits an alarm that enables the animal to be cognizant that it is required to return within the perimeter of the first displacement. In yet another alternate exemplary embodiment, an LED is adapted to be coupled to the animal managing device 191 that emits light and enables the animal to view the light and be cognizant that it is required to return within the perimeter of the first displacement from the electronic device 122.

A GPS (Global Positioning System) device 159 is adapted to be coupled to the control unit 112 of the electronic device 122. Alternatively, an animal tracking device capable of tracking a location of the animal within a user defined geographical boundary on a geographical map may be integrated in the electronic device 122. The terms ‘GPS device’, ‘animal tracking device’, and the like as described in the specification and in the claims may be construed to be used interchangeably to mean the same type of device.

The GPS device 159 is adapted to be used in combination with a geographical map. A geographical boundary on the geographical map may be defined on the electronic device 122 using a mouse, a finger or other drawing device. The geographical boundary can be a user defined boundary or be adapted to overlap natural boundary points such as a yard perimeter, an area within a park, or another private or public geographical boundary defined in the geographical map. When the animal managing device 191 approaches a perimeter of the geographical boundary, the ultrasonic device 132 is adapted to be activated by the electronic receiver 116/control unit 112. When the animal managing device 191 crosses a perimeter of the geographical boundary, the electric stimulus applying module 177 is adapted to be activated by the electronic receiver 116/control unit 112. When the animal managing device 191 is within a perimeter of the geographical boundary, the ultrasonic device 132 may not be activated. In an alternate exemplary embodiment, the speaker that is adapted to be coupled to the animal managing device 191 may be activated to emit the piercing sound/bothersome sound when the animal managing device 191 crosses a perimeter of the geographical boundary. When the animal managing device 191 crosses a perimeter of the geographical boundary, the electronic receiver 116 of the electronic device 122 receives an electronic signal from the electronic transmitter 165 of the animal managing device 191 that may be indicative that the animal managing device 191 has crossed a perimeter of the geographical boundary. The electronic receiver 116 of the electronic device 122 facilitates displaying a notification message on the digital display screen 25 notifying the user that the animal managing device 191 has crossed a perimeter of the geographical boundary.

The electronic device 122 may recognize and respond to the presence of the displacement area or GPS programmed geographical boundary of another electronic device. When a boundary of another electronic device comes in contact/proximate with a boundary of the electronic device 122, the perimeter of the geographical boundary of the electronic device 122 may be varied. Specifically, when the geographical boundary of another electronic device comes in contact/proximate with the geographical boundary of the electronic device 122, the boundary of the electronic device 122 may contract about the perimeter of the geographical boundary of the other electronic device or contract to a pre-defined perimeter. Moreover, when another electronic device is induced in electronic communication with the electronic device 122 by the user, the geographical boundary of the electronic device 122 and the geographical boundary of the other electronic device may merge to constitute a single geographical boundary that surrounds both the electronic devices. The perimeter of the single geographical boundary that surrounds both the electronic devices may be one of the larger and the smaller of the two geographical boundaries of the electronic device 122 and the geographical boundary of the other electronic device.

In an exemplary embodiment, the electronic transmitter 157 of the electronic device 122 may be in electronic communication with the GPS device 159. The electronic transmitter 157 is adapted to activate the electric stimulus applying module 177 to apply the electric stimulus on the animal when the animal managing device 191 crosses a perimeter of a geographical boundary.

In an exemplary embodiment of the invention, an animal deterrent device 199 is adapted to be in electronic communication with the animal managing device 191 to facilitate physical separation of a user of the animal deterrent device 199 and the managed animal. The animal deterrent device 199 is a device that may be external to the animal managing device 191 and is adapted to be operated by the user such as but not limited to a pizza delivery man, a milk delivery man, a mail delivery man, a gardener, a house keeper, a lawn mower man, a chauffeur, a repair man, a construction worker, a grocery delivery man, or any user that wishes to remain geographically separate from the animal. The animal deterrent device 199 facilitates applying an electric stimulus on the animal managing device 191 by means of the electric stimulus applying module 177. Specifically, when the user activates the animal deterrent device 199, the electric stimulus applying module 177 that may be in electronic communication with the animal deterrent device 199 applies an electric stimulus on the animal. When the user deactivates the animal deterrent device 199, the electric stimulus applying module 177 that is adapted to be in electronic communication with the animal deterrent device 199 may be deactivated. In an alternate exemplary embodiment, a proximity transducer (not shown) is adapted to be coupled to the animal deterrent device 199. When the animal managing device 191 approaches the animal deterrent device 199, the proximity transducer detects the approach of the animal managing device 191. When the animal managing device 191 reaches a pre-programmed displacement from the animal deterrent device 199, the animal deterrent device emits one of an audible sound and an ultrasonic sound to warn the animal to stop and withdraw away from the animal deterrent device 199. If the animal managing device 191 continues to approach the animal deterrent device 199, and crosses a displacement value that may be lesser than or equal to a pre-programmed displacement, the electric stimulus applying module 177 that is adapted to be in electronic communication with the animal deterrent device 199 applies the electric stimulus on the animal based on a trigger signal generated by the proximity transducer. When the animal managing device 191 withdraws away from the animal deterrent device 199 by a displacement value that may be greater than or equal to the pre-programmed displacement, the electric stimulus applying module 177 that is adapted to be in electronic communication with the animal deterrent device 199 may be deactivated. In an exemplary embodiment, the magnitude of this pre-programmed displacement may be programmable in the animal deterrent device 199 by the user. Alternatively, the magnitude of this pre-programmed displacement may be pre-programmed in the animal deterrent device 199 during a manufacturing/testing phase of the animal deterrent device 199. In an exemplary embodiment, the features of the animal deterrent device 199 may be integrated in the electronic device 122 itself. Alternatively, the animal deterrent device 199 may be the electronic device 122 that includes the components/features of the animal deterrent device 199. In an alternate exemplary embodiment, the speaker adapted to be coupled to the animal managing device 191 may be activated to emit a piercing sound/bothersome sound when the animal deterrent device 199 is activated. Specifically, when the user activates the animal deterrent device 199, the speaker that may be in electronic communication with the animal deterrent device 199 may be activated to emit the piercing sound/bothersome sound. When the user deactivates the animal deterrent device 199, the speaker that is adapted to be in electronic communication with the animal deterrent device 199 may be deactivated.

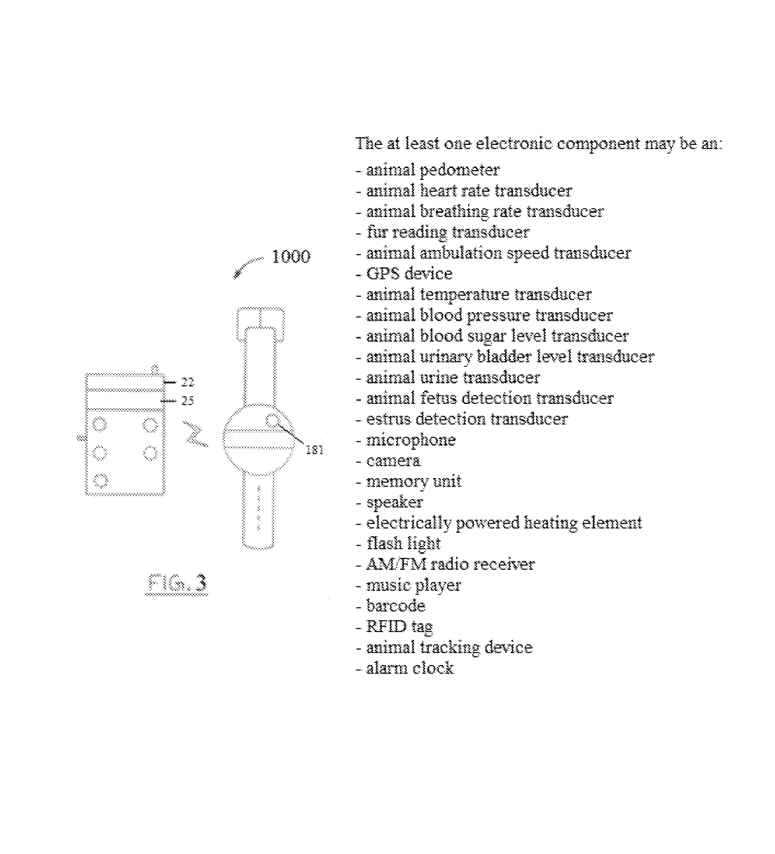

FIG. 3 is a schematic representation of at least one electronic component that may be coupled to the animal managing device. The animal managing device 191 includes the electronic transmitter 165 that is adapted to be coupled to the animal managing device 191. The electronic transmitter 165 is adapted to be coupled to at least one electronic component 181 that is coupled to the animal managing device 191. In an exemplary embodiment, the at least one electronic component 181 may be a pedometer such as utilized by the “Fitbark” product that is commercially available. The pedometer may detect a number of parameters pertaining to the animal. An electronic signal from the pedometer may be transmitted from the electronic transmitter 165 that may be coupled to the animal managing device 191 to the electronic receiver 116 of the electronic device 122 that may be indicative of the parameters that have been detected by the pedometer. The control unit 112 of the electronic device 122 may determine the parameters from the electronic signal that may be received by the electronic receiver 116 of the electronic device 122 from the pedometer. The parameters include but are not limited to a number of steps traversed by the animal, a time walked by the animal, a distance that has been covered by the animal, a distance that remains to be covered after the animal has covered a certain distance, and a number of calories expended by the animal. The control unit 112 facilitates digitally displaying the parameters on the digital display screen 25 to notify the user of the parameters that have been determined by the control unit 112. If the distance covered by the animal is lesser than/greater than a distance that may be programmed in the electronic device 122 by the user, the user may be notified accordingly.

During the normal operation of the pedometer, a walking sensor in the pedometer detects the vibration or motion of the animal's body at a time of walking to produce a signal output of one pulse at each walking step. The signal output of the walking sensor is inputted to a counter, which counts the number of the animal's walking steps. When an indicator selection switch is selected to a walking step indication, the indicator indicates the content of the counter. When the indicated number of steps is desired to be reset to “0”, a resetter is arbitrarily operated to clear the content of the counter, thereby resetting the counter and indicating “0” on the indicator.

In an exemplary embodiment, the at least one electronic component 181 includes a heart rate transducer that is adapted to be coupled to the animal managing device 191 such as utilized by the “Petpace”/“Voyce” products that are commercially available. More specifically, the heart rate transducer is adapted to be coupled to the animal managing device 191, and determines the animal's heart rate. An electronic signal from the heart rate transducer may be transmitted from the electronic transmitter 165 that may be coupled to the animal managing device 191 to the electronic receiver 116 of the electronic device 122 that may be indicative of the heart rate of the animal. The control unit 112 may determine the animal's heart rate from the electronic signal that may be received by the electronic receiver 116 of the electronic device 122 from the heart rate transducer. The control unit 112 facilitates digitally displaying the animal's heart rate on the digital display screen 25 to notify the user.

The heart rate transducer includes sensing means for sensing electrical activity of the animal's heart and for transmitting a signal derived from the electrical activity of the animal's heart such as utilized by the “Petpace”/“Voyce” products that are commercially available. The sensing means may be mounted on the chest of the animal. Signal receiving and processing means are provided that are independent of the sensing means for receiving a signal transmitted from the sensing means and for processing each signal.

In an exemplary embodiment, the at least one electronic component 181 may be a digital camera and/or motion video recorder such as utilized by the “Dogtek/Eyenimal” products that are commercially available. More specifically, the digital camera and/or motion video recorder that is adapted to be coupled to the animal managing device 191 allows the user to capture high quality images and/or audio and video recordings of the surroundings around the animal. The digital camera and/or motion video recorder is adapted to be activated and deactivated by the user by means of the electronic device 122. The digital camera and/or motion video recorder may be coupled to a memory unit (not shown). More specifically, the memory unit may store the captured images and/or audio and video recordings. An electronic signal from the digital camera and/or motion video recorder/memory unit may be transmitted from the electronic transmitter 165 that may be coupled to the animal managing device 191 to the electronic receiver 116 of the electronic device 122 that may be indicative of the surroundings around the animal. The captured images and/or audio and video recordings may also be transmitted from the digital camera and/or motion video recorder to any electronic device known in the art such as but not limited to a personal computer, a wireless router, a smart watch, a Bluetooth® device, a smart phone, and a smart container. The control unit 112 may post-process the captured images and/or audio and video recordings that may be received from the digital camera and/or motion video recorder. The control unit 112 facilitates digitally displaying the surroundings around the animal on the digital display screen 25. The terms camera, digital camera, video camera, analog camera, motion video recorder, and the like may be construed to be used interchangeably to mean the same type of device.

In an exemplary embodiment, the at least one electronic component 181 may be a temperature transducer such as utilized by the “Petpace” or “Voyce” products that are commercially available. More specifically, the temperature transducer of the animal managing device 191 may measure the animal's body temperature. An electronic signal from the temperature transducer is adapted to be transmitted from the electronic transmitter 165 that may be coupled to the animal managing device 191 to the electronic receiver 116 of the electronic device 122 that may be indicative of the animal's body temperature. The control unit 112 facilitates digitally displaying the animal's body temperature on the digital display screen 25 to notify the user of the animal's body temperature. In an alternate exemplary embodiment, the temperature transducer may be a thermometer that determines an ambient air temperature in the surroundings of the animal.

Each of the electronic components mentioned above may be coupled to prongs/probes that extend from the animal managing device 191 to push through the animal's fur and reach the skin of the animal. The prongs/probes may serve various purposes, such as to deliver an electric stimulus when required as well as transducers to perform various sensing and monitoring functions. The other sensing and monitoring functions performed by the prongs/probes are to sense/monitor pulse rate, blood oxygen saturation, temperature, respiration, blood pressure, ECG, blood sugar, and the like.

In an exemplary embodiment, the at least one electronic component 181 may be a breathing rate transducer that is adapted to be coupled to the animal managing device 191 such as utilized by the “Petpace” product that is commercially available. More specifically, the breathing rate transducer is adapted to be coupled to the animal managing device 191, and determines the animal's rate of breathing. An electronic signal from the breathing rate transducer may be transmitted from the electronic transmitter 165 that is adapted to be coupled to the animal managing device 191 to the electronic receiver 116 of the electronic device 122 that may be indicative of the breath rate of the animal. The control unit 112 may determine the animal's breath rate from the electronic signal that may be received by the electronic receiver 116 of the electronic device 122 from the breath rate transducer. The control unit 112 facilitates digitally displaying the animal's breath rate on the digital display screen 25 to notify the user.

In an exemplary embodiment, the at least one electronic component 181 may be an ambulation speed transducer that may be coupled to the animal managing device 191 such as utilized by the “Fitbark” product that is commercially available. More specifically, the ambulation speed transducer is adapted to be coupled to the animal managing device 191, and determines a speed at which the animal is moving on a terrain. An electronic signal from the ambulation speed transducer may be transmitted from the electronic transmitter 165 that may be coupled to the animal managing device 191 to the electronic receiver 116 of the electronic device 122 that may be indicative of the speed at which the animal is moving on the terrain. The control unit 112 may determine the speed at which the animal is moving on the terrain from the electronic signal that may be received by the electronic receiver 116 of the electronic device 122 from the ambulation speed transducer. The control unit 112 facilitates digitally displaying the speed at which the animal is moving on the terrain on the digital display screen 25 to notify the user.

In an exemplary embodiment, the at least one electronic component 181 may be a blood pressure transducer that may be coupled to the animal managing device 191 such as utilized by the “Petpace” and “Voyce” products that are commercially available. More specifically, the blood pressure transducer is adapted to be coupled to the animal managing device 191, and determines a blood pressure of the animal. An electronic signal from the blood pressure transducer may be transmitted from the electronic transmitter 165 that may be coupled to the animal managing device 191 to the electronic receiver 116 of the electronic device 122 that may be indicative of the blood pressure of the animal. The control unit 112 may determine the blood pressure of the animal from the electronic signal that may be received by the electronic receiver 116 of the electronic device 122 from the blood pressure transducer. The control unit 112 facilitates digitally displaying the blood pressure of the animal on the digital display screen 25 to notify the user.

In an exemplary embodiment, the at least one electronic component 181 may be a fur reading transducer that may be coupled to the animal managing device 191. More specifically, the fur reading transducer is adapted to be coupled to the animal managing device 191, and gathers various data from the fur of the animal. An electronic signal from the fur reading transducer may be transmitted from the electronic transmitter 165 that may be coupled to the animal managing device 191 to the electronic receiver 116 of the electronic device 122 that may be indicative of the various data gathered from the fur of the animal. The control unit 112 may determine the various data gathered from the fur of the animal from the electronic signal that may be received by the electronic receiver 116 of the electronic device 122 from the fur reading transducer. The control unit 112 facilitates digitally displaying the various data gathered from the fur of the animal on the digital display screen 25 to notify the user.

In an exemplary embodiment, the at least one electronic component 181 may be a blood sugar level transducer that may be coupled to the animal managing device 191 such as utilized by the “Apple Watch” product that is commercially available. More specifically, the blood sugar level transducer is adapted to be coupled to the animal managing device 191, and determines a blood sugar level of the animal. An electronic signal from the blood sugar level transducer may be transmitted from the electronic transmitter 165 that may be coupled to the animal managing device 191 to the electronic receiver 116 of the electronic device 122 that may be indicative of the blood sugar level contained in the animal. The control unit 112 may determine the blood sugar level contained in the animal from the electronic signal that may be received from the blood sugar level transducer. The control unit 112 facilitates digitally displaying the blood sugar level of the animal on the digital display screen 25 to notify the user.

In an exemplary embodiment, the blood sugar level transducer may also be utilized to measure hunger. More specifically, the blood sugar level transducer is adapted to be coupled to the animal managing device 191, and determines a hunger level situation of the animal. Specifically, the blood sugar level transducer may be utilized to determine a lack of blood sugar as an indicator for a need for nutrients in the animal. If the indicated blood sugar level measurement is below a pre-programmed threshold, an electronic signal from the blood sugar level transducer may be transmitted from the electronic transmitter 165 that is adapted to be coupled to the animal managing device 191 to the electronic receiver 116 of the electronic device 122 that may be indicative of the hunger level of the animal. The control unit 112 may determine the hunger level of the animal from the electronic signal that may be received from the blood sugar level transducer. The control unit 112 facilitates digitally displaying the hunger level of the animal on the digital display screen 25 to notify the user.

In an exemplary embodiment, the at least one electronic component 181 may be a urinary bladder level transducer that may be coupled to the animal managing device 191 such as that offered by the “Brightly” bladder sensor that is commercially available. More specifically, the urinary bladder level transducer is adapted to be coupled to the animal managing device 191, and determines a urine level of the animal. Specifically, the urinary bladder level transducer may be an ultrasonic transducer that transmits and receives ultrasonic signals to a urinary bladder of the animal. If the received ultrasonic signal is of a first frequency, it may imply that the urinary bladder of the animal is full. If the received ultrasonic signal is of a second frequency, it may imply that the urinary bladder of the animal is one of partially full and empty. An electronic signal from the urinary bladder level transducer may be transmitted from the electronic transmitter 165 that may be coupled to the animal managing device 191 to the electronic receiver 116 of the electronic device 122 that may be indicative of the urine level in the urinary bladder of the animal. The control unit 112 may determine the urine level in the urinary bladder of the animal from the electronic signal that may be received from the urinary bladder level transducer. The control unit 112 facilitates digitally displaying the urine level in the urinary bladder of the animal on the digital display screen 25 to notify the user when the animal may need to be taken outdoors.

In an exemplary embodiment, the at least one electronic component 181 may be a barcode that may be coupled/integrated to the animal managing device 191. More specifically, the barcode is adapted to be coupled to the animal managing device 191, and contains an identity of the animal. An electronic signal from the barcode may be transmitted from the electronic transmitter 165 that may be coupled to the animal managing device 191 to the electronic receiver 116 of the electronic device 122 that may be indicative of the identity of the animal. The identity of the animal may be a unique identification parameter associated with that animal which differentiates it from other animals that may be coupled to animal managing devices. The control unit 112 may determine the identity of the animal from the electronic signal that may be received from the barcode. The control unit 112 facilitates digitally displaying the identity of the animal on the digital display screen 25 to notify the user. Alternatively, the identity of the animal may be extracted from the barcode by means of a barcode scanner, wherein the barcode scanner may be integrated within/coupled to the electronic device 122. The barcode scanner may also be an independent barcode scanning device.

In an exemplary embodiment, the at least one electronic component 181 may be an RFID tag that may be coupled/integrated to the animal managing device 191. More specifically, the RFID tag is adapted to be coupled to the animal managing device 191, and determines an identity of the animal/parameters associated with the animal. An electronic signal from the RFID tag may be transmitted from the electronic transmitter 165 that may be coupled to the animal managing device 191 to the electronic receiver 116 of the electronic device 122 that may be indicative of the identity of the animal/parameters associated with the animal. The identity of the animal/parameters associated with the animal may be a unique identification parameter associated with that animal which differentiates it from other animals that may be coupled to animal managing devices. The control unit 112 may determine the identity of the animal/parameters associated with the animal from the electronic signal that may be received from the RFID tag. The control unit 112 facilitates digitally displaying the identity of the animal/parameters associated with the animal on the digital display screen 25 to notify the user. Alternatively, the identity of the animal/parameters associated with the animal may be extracted from the RFID tag by means of an RFID reader, wherein the RFID reader may be integrated within/coupled to the electronic device 122. The RFID reader may also be an independent RFID tag reading device.

In an exemplary embodiment, the at least one electronic component 181 may be one of an estrus detection transducer such as utilized by the “Silent Herdsmen” product that is commercially available, and a fetus detection transducer that may be coupled to the animal managing device 191. Specifically, the fetus detection transducer may be an ultrasonic transducer that transmits and receives ultrasonic signals to a uterus of the animal. If the received ultrasonic signal is of a first frequency, it may imply that the animal contains a fetus within it. If the received ultrasonic signal is of a second frequency, it may imply that the animal does not contain a fetus within it. An electronic signal from the fetus detection transducer/estrus detection transducer may be transmitted from the electronic transmitter 165 that may be coupled to the animal managing device 191 to the electronic receiver 116 of the electronic device 122 that may be indicative of the presence of the fetus in the animal/current stage of fetus development in the animal/the ‘in heat’ state of the animal. The control unit 112 may determine the presence of the fetus in the animal/current stage of fetus development/the ‘in heat’ state of the animal from the electronic signal that may be received from the fetus detection transducer/the estrus detection transducer. The control unit 112 facilitates digitally displaying the images of the fetus/current stages of fetus development/fetus parameters/‘in heat’ state of the animal, and the like on the digital display screen 25 to notify the user.

In an exemplary embodiment, the at least one electronic component 181 may be a urine transducer that may be coupled to the animal managing device 191. More specifically, the urine transducer is adapted to be coupled to the animal managing device 191, and determines a constitution of urine of the animal. As an example, a constitution of urine of the animal may include a concentration level of urea, sugar, protein, amino acids, chloride, creatinine, potassium salts, sodium salts, and the like that may be present in the urine of the animal. An electronic signal from the urine transducer may be transmitted from the electronic transmitter 165 that may be coupled to the animal managing device 191 to the electronic receiver 116 of the electronic device 122 that may be indicative of the constitution of urine of the animal. The control unit 112 may determine the concentration of urea, sugar, protein, amino acids, chloride, creatinine, potassium salts, sodium salts, and the like that may be present in the urine of the animal from the electronic signal that may be received from the urine transducer. The control unit 112 facilitates digitally displaying the concentration of urea, sugar, protein, amino acids, chloride, creatinine, potassium salts, sodium salts, and the like that may be present in the urine of the animal on the digital display screen 25 to notify the user.

In an exemplary embodiment, the at least one electronic component 181 may be a microphone. More specifically, the microphone is adapted to be coupled to the animal managing device 191, and captures an audible sound emitted from the animal. An electronic signal from the microphone may be transmitted from the electronic transmitter 165 that may be coupled to the animal managing device 191 to the electronic receiver 116 of the electronic device 122 that may be indicative of the audible sound that is emitted from the animal. The control unit 112 may determine the audible sound emitted from the animal from the electronic signal that may be received from the microphone. The control unit 112 facilitates playing the audible sound that may be emitted from the animal in the electronic device 122 to notify the user. If the audible sound emitted from the animal is above a threshold decibel level, the electronic receiver 116 facilitates activating the ultrasonic device 132 to emit the signal of the first ultrasonic frequency. Alternatively, if the audible sound emitted from the animal is above the threshold decibel level, the electronic receiver 116 facilitates activating the electric stimulus applying module 177 to apply the electric stimulus on the animal. In yet another alternate exemplary embodiment, the electronic receiver 116 facilitates activating the ultrasonic device 132 to emit the signal of the first ultrasonic frequency/facilitates activating the electric stimulus applying module 177 to apply the electric stimulus on the animal when the audible sound emitted from the animal is above a threshold period of time. A value of the threshold period of time/threshold decibel level may each be programmable in the electronic device 122 by the user. In an alternate exemplary embodiment, an electronic signal from the microphone may be transmitted from the electronic transmitter 165 that may be coupled to the animal managing device 191 to the electronic receiver 116 of the electronic device 122 that may be indicative of certain noise patterns. In an exemplary embodiment, the noise patterns may be but are not limited to “a whining noise”, “an angry bark”, “an aggressive growl”, “an intermittent bark”, “a purr” and the like that may be used to express a current state of the animal. Based on the type of received noise pattern, electronic devices such as a door, food dispenser, and the like may be operated by the electronic device 122.

In an exemplary embodiment, the at least one electronic component 181 may be a GPS device. More specifically, the GPS device is adapted to be coupled to the animal managing device 191, and determines a geographical location of the animal as utilized by the “Tagg Pet Tracker” product that is commercially available. An electronic signal from the GPS device may be transmitted from the electronic transmitter 165 that may be coupled to the animal managing device 191 to the electronic receiver 116 of the electronic device 122 that may be indicative of the geographical location of the animal. The control unit 112 may determine the geographical location of the animal from the electronic signal that may be received from the GPS device. The control unit 112 facilitates digitally displaying the geographical location of the animal on the digital display screen 25 to notify the user.

The electronic receiver 116 of the electronic device 122 facilitates activating the ultrasonic device 132 to emit the first ultrasonic frequency signal when the electronic signal received from one of the animal pedometer, the animal heart rate transducer, the animal breathing rate transducer, the animal ambulation speed transducer, the GPS device, the animal temperature transducer, the animal blood pressure transducer, the animal blood sugar level transducer, the animal urinary bladder level transducer, and the animal urine transducer exceeds a threshold signal that may be programmed in the electronic device 122 by the user.

In an alternate exemplary embodiment, the electronic receiver 116 of the electronic device 122 facilitates activating the electric stimulus applying module 177 to apply the electric stimulus on the animal when the electronic signal received from one of the animal pedometer, the animal heart rate transducer, the animal breathing rate transducer, the animal ambulation speed transducer, the GPS device, the animal temperature transducer, the animal blood pressure transducer, the animal blood sugar level transducer, the animal urinary bladder level transducer, and the animal urine transducer exceeds a threshold signal that may be programmed in the electronic device 122 by the user.

In an exemplary embodiment, the at least one electronic component 181 may be a memory unit that is adapted to be coupled to the animal managing device 191. The memory unit may be electronically coupled to the electronic receiver 183 of the animal managing device 191 and acquires and stores the electronic signal from the electronic receiver 183. More specifically, the memory unit may acquire and store a finite list of entries that includes a finite number of log entries that may be received from the electronic device 122. The memory unit automatically deletes the oldest of the stored log entries in chronological order as the latest log entries are continuously acquired and stored by the memory unit from the electronic receiver 183. The memory unit may also be adapted to be in electronic communication with an alarm clock which may be activated to wake up the animal at a specific time in a day or night. In an alternate exemplary embodiment, the memory unit may be interchangeable with any memory device such as but not limited to a computer chip, an integrated circuit, a memory card, a memory stick, and a magnetic medium. In an exemplary embodiment, the animal managing device 191 may be provided with a slot/USB port (not shown) on the outer sidewall of the animal managing device 191 for receiving the memory unit therein. The alarm clock may also be configured to transmit an electronic signal to the electronic transmitter 165 of the animal managing device 191 at a specific time that has been programmed by the user. The electronic transmitter 165 then transmits a corresponding electronic signal to an alarm device that is located remotely from the animal managing device 191 such as inside a home so as to beckon the animal towards the alarm device.

The at least one electronic component 181 may be an electrically powered heating element coupled to a periphery of the animal managing device 191. Thus, as the electrically powered heating element of the animal managing device 191 is powered by electricity, the electrically powered heating element generates heat. The heat generated by the electrically powered heating element warms the animal that is in contact with the animal managing device 191 when directed by the user by means of the electronic device 122. In an alternate exemplary embodiment, an infrared heater is adapted to be coupled to the periphery of the animal managing device 191 to warm the animal that is in contact with the animal managing device 191. The electrically powered heating element may alternatively be any heating source known in the art that facilitate warming the animal that is in contact with the animal managing device 191.

The electrically powered heating element may be controlled by the user for a range of operations from mild warming to quick warming depending on the user's preference. More specifically, the animal managing device 191 may be provided with ascending power levels 1-5. By selecting the power level 1, the animal may be warmed to a lower temperature by supplying the electrically powered heating element with low power. By selecting the power level 5, the animal may be warmed to a higher temperature by supplying the electrically powered heating element with high power. Alternatively, the power levels 1-5 may signify the time taken to warm the animal in ascending/descending order.

In an exemplary embodiment, the at least one electronic component 181 may be a flash light. More specifically, the flash light is adapted to be coupled to the animal managing device 191 and may emit a beam of light from a light source. More specifically, the flash light may be in electronic communication with a switch (not shown) that is coupled to the electronic device 122 and illuminates a path of the animal when the switch may be operated by the user. In an exemplary embodiment, the flash light may be remotely activated by the user by means of the electronic transmitter 157 that may be coupled to a switch of the electronic device 122 and in electronic communication with the electronic receiver 183 of the animal managing device 191. The flash light comprises a light bulb mounted on a reflector and a transparent cover to protect the light source. The reflector may be used to reflect the beam of light that is emitted from the light source. The flash light facilitates illuminating a path along a line of sight of the animal.

The at least one electronic component 181 may be an AM/FM radio receiver that is adapted to be coupled to the animal managing device 191 and in electronic communication with the electronic receiver 183 of the animal managing device 191. More specifically, the user may monitor a current radio station from the electronic device 122, and toggle between various AM/FM radio stations using the touch screen selector that is provided on the electronic device 122. In an exemplary embodiment, the AM/FM radio receiver may be integrally or removably coupled to the animal managing device 191. The AM/FM radio receiver comprises a radio tuner having a radio frequency input and an audio output for providing a radio audio signal. The AM/FM radio receiver is adapted to be coupled to the speaker. The radio audio signal may be transmitted from the AM/FM radio receiver to the speaker via a plurality of electronic modulating components for communicating the radio audio signal to the animal. The volume level of the speaker may be increased or decreased by using the touch screen selector provided on the electronic device 122. In an exemplary embodiment, an AM/FM radio signal may be transmitted from the electronic device 122 to the electronic receiver 183 that is adapted to be coupled to the animal managing device 191. The speaker may also be adapted to play one of a message from a user such as but not limited to a voice command of the user directing the animal to perform certain functions, and a pre-recorded sound such as but not limited to food being poured into a bowl at specific times in a day to induce the animal to return to a location that is known to it and the user. The speaker that may be adapted to play one of a message from the user/the pre-recorded sound may be initiated by the user from the electronic device 122. Alternatively, the speaker that may be adapted to play one of the message from the user/the pre-recorded sound may be played at pre-programmed times/time intervals during a course of a day.

The at least one electronic component 181 may be a digital music player that is adapted to be coupled to the animal managing device 191. More specifically, the user may select a desired song track from a plurality of song tracks stored in the memory unit, wherein the memory unit may be in electronic communication with the digital music player. The digital music player is adapted to be coupled to the speaker. A desired song track signal may be transmitted from the digital music player to the speaker in order to play the desired song track for the animal. In an alternate exemplary embodiment, the digital music player may be remotely controlled by the user by transmitting an electronic signal from the electronic transmitter 157 of the electronic device 122 to the electronic receiver 183 of the animal managing device 191. In an exemplary embodiment, when the plurality of light emitting sources/light emitting source displays various colors, flickers on and off in a sequence, strobes, cycles in various user programmed sequences, one of the radio tuner and the digital music player may be activated simultaneously for a pre-programmed duration of time. Alternatively, one of the radio tuner and the digital music player may be activated simultaneously and remains in operation until deactivated by the user by means of the electronic device 122. It may be understood by one skilled in the art that each of the at least one electronic components 181 described above may be in electronic communication with one another and with the electronic receiver 183 and the electronic transmitter 165 of the animal managing device 191.

In an exemplary embodiment, the animal managing device 191 may be manufactured from a water resistant material. Specifically, all the electronic components that are adapted to be coupled/integrated within the animal managing device 191 may be manufactured from the water resistant material/insulated within the water resistant material of the animal managing device 191 to facilitate insulating the animal managing device 191 from water caused by rain, water puddles, swimming pools, water bodies, bath tubs, and the like which the animal may encounter.

In an exemplary embodiment, the animal managing device 191 may be manufactured using a rugged design/ruggedness imparting wear resistant material. Specifically, all the electronic components that are adapted to be coupled/integrated within the animal managing device 191 may be manufactured from the wear resistant material/insulated within the wear resistant material of the animal managing device 191 to facilitate insulating the animal managing device 191 from wear caused by exposure to tough day-to-day environments which the animal may encounter.

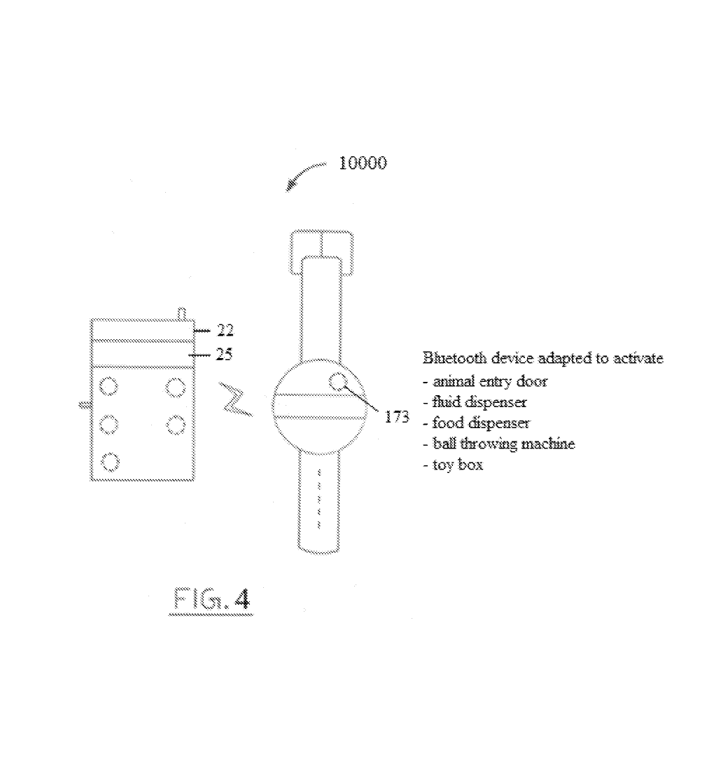

FIG. 4 is a schematic representation of a Bluetooth® device that may be coupled to the animal managing device and adapted to operate an accessory. The animal managing device 191 includes a Bluetooth® device 173. The Bluetooth® device 173 that may be coupled to the animal managing device 191 may be adapted to operate an animal entry door to a shelter. Specifically, an electronic transducer that may be coupled to/proximate to the animal entry door may detect the Bluetooth® device 173 and open the animal entry door for the animal to enter the shelter. The Bluetooth® device 173 may be coupled to the electronic transmitter 165, electronic receiver 183, and the digital display 163.

The Bluetooth® device 173 that may be coupled to the animal managing device 191 may be adapted to operate a fluid dispenser. Specifically, an electronic transducer that may be adapted to be coupled to/proximate to the fluid dispenser may detect the Bluetooth® device 173 and open a tap of the fluid dispenser for the animal to drink fluids.

The Bluetooth® device 173 that may be coupled to the animal managing device 191 may be adapted to operate a food dispenser as utilized by the “Pintofeed” product that is commercially available. Specifically, an electronic transducer that may be adapted to be coupled to/proximate to the food dispenser may detect the Bluetooth® device 173 and open the food dispenser for allowing a pre-determined quantity of food to flow out of the food dispenser.

The Bluetooth® device 173 that may be coupled to the animal managing device 191 may be adapted to operate a ball throwing machine as utilized in the “GoDogGo” fetch machine that is commercially available. Specifically, an electronic transducer that may be adapted to be coupled to/proximate to the ball throwing machine may detect the Bluetooth® device 173 and throw a ball for the animal to fetch.

The Bluetooth® device 173 that may be coupled to the animal managing device 191 may be adapted to operate a toy box. Specifically, an electronic transducer that is adapted to be coupled to/proximate to the toy box may detect the Bluetooth® device 173 and release a toy from within for the animal to play. In alternate embodiments, the Bluetooth® device 173 that may be coupled to the animal managing device 191 may be adapted to operate any electronic device that is known in the art that assists the animal that may be coupled to the animal managing device 191 for performing any function.

A touch screen selector is adapted to be coupled to/integrated in the electronic device 122. The touch screen selector may be in electronic communication with the ultrasonic device 132. The touch screen selector may be operated by the user to activate the ultrasonic device 132, which emits the first ultrasonic frequency signal. In addition/alternatively, a selector option switch 120 is adapted to be coupled to the electronic device 122 and in electronic communication with the ultrasonic device 132. The selector option switch 120 may be operated by the user to activate the ultrasonic device 132 which emits the first ultrasonic frequency signal.

In an exemplary embodiment of the invention, a digital display 163 is adapted to be coupled to the animal managing device 191, and may be in electronic communication with the electronic receiver 183 and the memory unit of the animal managing device 191. The digital display 163 may display at least one of a name of the animal, a unique identifier associated with the animal, a unique identification number associated with the animal, a name of a person responsible for the animal, a breed of the animal, an address of the person responsible for the animal, an e-mail address of the person responsible for the animal, and a telephone number of the person responsible for the animal. The memory unit may be used to store this information by the user by means of the electronic device 122, wherein this information may be transmitted to the electronic transmitter 165 that may be coupled to the animal managing device 191. In an alternate embodiment, the digital display 163 may be programmable by the user by means of a key pad (not shown) that may be coupled to the animal managing device 191 and in electronic communication with the digital display 163. The information may be stored within the memory unit that may be in electronic communication with the electronic receiver 116 and may be transmitted to the electronic receiver 116 of the electronic device 122 by means of the electronic transmitter 165.

The animal management system 100 includes a light emitting source (not shown) coupled to the electronic receiver 183 of the animal managing device 191 that is similar to the “Halo Mini” product that is commercially available. In an exemplary embodiment, the light emitting source may be a light emitting diode. In an alternate embodiment, the light emitting source may be a laser. In yet another alternate embodiment, the light emitting source may be any type of light emitting source known in the art that facilitates identifying the animal by the user. The light emitting source that is adapted to be coupled to the animal managing device 191 may alternatively be a plurality of light emitting sources that may be coupled to the animal managing device 191. The light emitting source may be in electronic communication with the electronic receiver 116 of the electronic device 122. When the user transmits an electronic signal from the electronic transmitter 157 of the electronic device 122 to the electronic receiver 183 of the animal managing device 191, the light emitting source may be illuminated. In an exemplary embodiment, the light emitting source may be activated for a pre-programmed duration of time. In an alternate exemplary embodiment, the light emitting source may be activated as long as the user activates the electronic device 122. In an exemplary embodiment, the user may activate a user controlled activator that may be integrated within the electronic device to activate the light emitting source. The user controlled activator may be a mechanical or touch screen activator.

A light transducer (not shown) may be in electronic communication with the light emitting source. The light transducer detects the light level in proximity of the animal managing device 191. If the light level in the proximity of the animal managing device 191 is lower than a pre-programmed threshold value, the light emitting source may be activated to emit light and thereby provide identification of the animal to the user. The plurality of light emitting sources/light emitting source may be programmed in the electronic device 122/self programmed to display various colors, flicker on and off in a sequence, strobe, cycle in various user programmed sequences for a fun/decorative effect. Alternatively, the plurality of light emitting sources/light emitting source may illuminate a path along a line of sight of the animal.

The above described animal management system 100 is cost effective and highly reliable. In addition, the modular nature of each sub-system of the animal management system 100 facilitates easy disassembly and replacement of individual system components as required. The terms ‘in electronic communication with’, ‘electronically coupled’, ‘coupled to’, ‘connected’, ‘integrated’ and the like as described in the specification and in the claims may be construed to be used interchangeably. Moreover, the terms ‘may be’, ‘adapted to be’, ‘is’, ‘are’, and the like as described in the specification and in the claims may be construed to be used interchangeably.

In accordance with a recognized need, there has been developed an animal management system to satisfy many users' animal managing and data gathering requirements. The electronic device 122 that may be located remotely from the animal managing device 191 is compact and easily interchangeable with electronic devices of various types such as cell phones, smart containers, smart watches, pagers, remote control devices, Bluetooth® devices, CDMA devices, radio frequency devices, computer systems, and the like. It is a versatile device which can be used to receive/transmit electronic signals from/to the animal managing device, as well as perform the function of gathering data/parameters from the animal via the animal managing device. Importantly, the animal management system 100 is efficient in operation.

Exemplary embodiments of an animal management system 100 are described above in detail. The system is not limited to the specific embodiments described herein, but rather, components of each system may be utilized separately and independently from other components described herein.

While the invention has been described in terms of various specific embodiments, those skilled in the art will recognize that the invention can be practiced with modifications within the spirit and scope of the claims.

1. An animal management system, said animal management system comprising:
an animal managing device, wherein said animal managing device is adapted to be coupled to an animal;
an electronic device in electronic communication with said animal managing device, said electronic device comprising:
an electronic receiver, said electronic receiver adapted to receive a first electronic signal from said animal managing device; and
a sound emitting device in electronic communication with said electronic receiver, said electronic receiver adapted to activate said sound emitting device to emit at least one of an audible sound and a first ultrasonic frequency signal when said animal managing device reaches a first displacement from said electronic device.

2. (canceled)

3. An animal management system in accordance with claim 1 further comprising a control unit in electronic communication with at least one of said electronic receiver and the said sound emitting device, said control unit adapted to activate said sound emitting device to emit at least one of the audible sound and the first ultrasonic frequency signal when said animal managing device reaches the first displacement from said electronic device.

4. (canceled)

5. (canceled)

6. An animal management system in accordance with claim 1 wherein said electronic device further comprises a digital display screen adapted to display a location of said animal managing device with reference to said electronic device.

7. An animal management system in accordance with claim 1 wherein said electronic device further comprises a GPS device coupled to said electronic receiver and adapted to contain a geographical map and a geographical boundary defined by a user on said geographical map, wherein said electronic receiver is adapted to activate said sound emitting device when said animal managing device crosses a perimeter of the geographical boundary.

8. (canceled)

9. An animal management system in accordance with claim 7 wherein the perimeter of the geographical boundary may be varied when one of:
a geographical boundary of another electronic device comes in contact/proximate to the geographical boundary of said electronic device; and
another electronic device is induced in electronic communication with said electronic device.

10. An animal management system in accordance with claim 1 wherein said electronic receiver is adapted to activate said sound emitting device to emit at least one of the audible sound and a second ultrasonic frequency signal when said animal managing device reaches a second displacement from said electronic device, said second displacement is greater than said first displacement.

11. (canceled)

12. An animal management system in accordance with claim 10 further comprising an electric stimulus applying module coupled to said animal managing device, said electric stimulus applying module activated to apply an electric stimulus on said animal when said animal managing device reaches a third displacement from said electronic device, said third displacement being greater than said second displacement.

13. An animal management system in accordance with claim 12 wherein said electric stimulus applying module is adapted to be in electronic communication with said electronic device, and wherein said electric stimulus applying module is adapted to be activated using said electronic device by a user controlled activator.

14. (canceled)

15. (canceled)

16. (canceled)

17. An animal management system in accordance with claim 12 further comprising an electronic transmitter adapted to be coupled to said animal managing device, said electronic transmitter adapted to be in electronic communication with at least one electronic component coupled to said animal managing device, wherein said at least one electronic component is selected from a group consisting of: an animal pedometer, an animal heart rate transducer, an animal breathing rate transducer, a fur reading transducer, an animal ambulation speed transducer, a GPS device, an animal temperature transducer, an animal blood pressure transducer, an animal blood sugar level transducer, an animal urinary bladder level transducer, an animal urine transducer, an animal fetus detection transducer, an estrus detection transducer, a microphone, a camera, a memory unit, a speaker, an electrically powered heating element, a flash light, an AM/FM radio receiver, a music player, a barcode, and an RFID) tag.

18. An animal management system in accordance with claim 17 wherein said electronic transmitter adapted to be in electronic communication with said electronic receiver of said electronic device, said electronic receiver adapted to receive a second electronic signal from said electronic transmitter, wherein the second electronic signal includes at least one of an animal pedometer signal, an animal heart rate signal, an animal breathing rate signal, an animal ambulation speed signal, an animal emitted vocal signal, an animal geographical location signal, an animal temperature signal, an animal fur parameter signal, an animal blood pressure signal, an animal blood sugar level signal, an animal hunger level signal, an animal urinary bladder level signal, an animal fetus detection signal, an estrus detection signal, an animal urine signal, a camera signal, a barcode signal, and an RFID signal.

19. An animal management system in accordance with claim 18 wherein said electronic receiver adapted to activate said sound emitting device to emit one of the audible sound and the first ultrasonic frequency signal when the second electronic signal received by said electronic receiver exceeds a pre-programmed threshold signal.

20. (canceled)

21. An animal management system in accordance with claim 18 wherein said electric stimulus applying module adapted to be activated by said electronic device to apply the electric stimulus on said animal when the animal emitted vocal signal exceeds at least one of a pre-programmed threshold animal emitted vocal signal and a pre-programmed duration of time.

22. An animal management system in accordance with claim 1 wherein said electronic device is selected from a group consisting of:
a cell phone, a smart container, a wrist watch, a pager, a remote control device, a Bluetooth® device, a CDMA device, a radio device, a computer system, a Wi-Fi device, a GPS device, and an RFID reader.

23. An animal management system in accordance with claim 1 wherein said electronic device is adapted to be programmable by a user to increase and decrease a range of said first displacement.

24. An animal management system in accordance with claim 1 further comprising at least one light emitting source coupled to said animal managing device, said at least one light emitting source adapted to emit light when one of:
a user controlled activator activates said at least one light emitting source, said user controlled activator integrated in said electronic device; and
a light transducer in electronic communication with said at least one light emitting source detects that light in a proximity of said animal managing device is lower than a pre-programmed light level.

25. An animal management system in accordance with claim 1 further comprising at least one of a touch screen selector and a selector option switch coupled to said electronic device and in electronic communication with said sound emitting device, at least one of said touch screen selector and said selector option switch adapted to activate said sound emitting device which emits one of the audible sound and the first ultrasonic frequency signal.

26. An animal management system in accordance with claim 1 further comprising a digital display coupled to said animal managing device, said digital display adapted to display at least one of a name of said animal, a unique identifier associated with said animal, a unique identification number associated with said animal, a breed of said animal, a name of a person responsible for said animal, an address of said person responsible for said animal, an e-mail address of said person responsible for said animal, and a telephone number of said person responsible for said animal.

27. An animal management system in accordance with claim 1 further comprising a Bluetooth® device coupled to said animal managing device, said Bluetooth® device adapted to activate an accessory, wherein said accessory comprises an animal entry door, a fluid dispenser, a food dispenser, a ball throwing machine, and a toy box.

28. (canceled)

29. (canceled)

30. An animal management system, said animal management system comprising:
an animal managing device, wherein said animal managing device adapted to be coupled to an animal;
an electric stimulus applying module coupled to said animal managing device; and
an animal deterrent device in electronic communication with said electric stimulus applying module, said animal deterrent device facilitates applying an electric stimulus on said animal by means of said electric stimulus applying module when one of:
said animal managing device reaches a pre-programmed displacement from said animal deterrent device; and
said electric stimulus applying module is activated using said animal deterrent device by a user controlled activator.

31.-49. (canceled)

50. An electronic device for managing an animal, said electronic device comprising;
an electronic receiver coupled to said electronic device, said electronic receiver in electronic communication with an animal managing device;
a sound emitting device in electronic communication with said electronic receiver; and
an animal tracking device in electronic communication with said electronic receiver and adapted to contain a geographical map and a geographical boundary defined by a user on said geographical map, wherein said electronic receiver is adapted to activate said sound emitting device to emit one of an audible sound and an ultrasonic frequency signal when said animal managing device crosses a perimeter of the geographical boundary.

51.-85. (canceled)
